(19) United States
(12) Patent Application Publication
(10) Pub. No.: US 2025/0290536 A1
(43) Pub. Date: Sep. 18, 2025

(54) QUICK INSTALL NUT

(71) Applicant: Globe Union Industrial Corp., Taichung City (TW)

(72) Inventors: Chao-Ta Yang, Taichung City (TW); Hsin-Jen Wang, Taichung City (TW)

(21) Appl. No.: 19/057,152

(22) Filed: Feb. 19, 2025

(30) Foreign Application Priority Data
Mar. 15, 2024 (CN) 2024205118314

(51) Int. Cl. F16B 37/08

(52) U.S. Cl. CPC F16B 37/0814

(57) ABSTRACT

A quick install nut includes a threaded member and a driving member rotatably connected to the threaded member. The nut is tilted and mounted to a bolt and two segments of threads staggered relatively inside the threaded member are engaged with the bolt after the nut being returned. By the driving member rotating the threaded member, a closed ring in the driving member allows the bolt to be closed inside the nut, forces the bolt engaged with the threaded member, and drives the nut to be fastened tightly to the bolt. The closed ring is moved with the driving member. The threaded member can have only single segment of threads so that the bolt enters the nut horizontally. Thereby the bolt keeps engaged with the nut during mounting and fastening of the nut. Therefore, quick and firm fastening is achieved.

### FIELD OF THE INVENTION

The present invention relates to a nut, especially to a quick install nut.

### BACKGROUND OF THE INVENTION

For many devices, equipment or accessories, long threaded members such as threaded rods, bolts, and threaded tubes are required to be used in combination with nuts for threaded engagement and fastening. Yet in some conditions, the nut must be rotated and moved on the threaded member for a long distance for fastening and thus certain problems are derived. For instance, time for threading operation is long so that installation efficiency is reduced. A narrow space for installation and operation adversely affects rotation and operation of the nut with long stroke. The nut may be even unable to be fastened on the bolt due to difficulty in rotation and force applying.

In order to overcome shortcomings of the conventional nut mentioned above, a quick install nut is provided in Chinese Pat. Pub. No. CN 219795808 U. The nut includes an entrance end, an exit end, a half-shell first threaded portion corresponding to the entrance end, and a half-shell second threaded portion corresponding to the exit end and connected with the first threaded portion. The first threaded portion includes a first slot, a segment of first internal thread formed on an inner surface of the first slot, and a first relief space communicating with a radial opening of the first slot. The second threaded portion is composed of a second slot, a segment of second internal thread formed on an inner surface of the second slot, and a second relief space communicating with a radial opening of the second slot. The first slot and the second slot are disposed on a central axis of the quick install nut in a staggered manner so that the radial openings of the first and the second slots are in opposite directions with a 180-degree angle between the radial openings. A compression wall is formed on the first threaded portion.

The quick install nut revealed in the above patent can be applied to various types of faucets or bathroom equipment, especially different types of toilets including side-fastened toilet, one-piece toilet, and two-piece toilet. Users can tighten or loosen the nut by manual operation or rotation with specific tools. One of the installation ways is to insert two fixing bolts already fixed on one toilet flange through two opposite installation holes on a bottom wall of the side-fastened toilet from bottom to top. Then insert two nuts through operation holes on two side walls of the side-fastened toilet and directly mount the nuts to the fixing bolts from top to bottom quickly for threading and securing the nuts to the fixing bolts. Thereby the side-fastened toilet is quickly installed and fastened on the toilet flange and the surrounding floor.

Another installation way is about the same as the above way and the difference between the two ways is only in that: the second threaded portion of the nut is further provided with a locking portion having a plurality of locking slots formed thereon. The installers can use and insert a turning tool such as a slotted screwdriver or a cruciform screwdriver through the operation hole of the side-fastened toilet or the one-piece toile and then mount and position the turning tool in the two opposite locking slots for turning operation.

However, the quick install nut with the above design still has certain shortcomings. For example, under the condition that the installer is difficult to operate the nut manually or indirectly rotating the nut by tools, the installer may be unable to control the nut and keep the nut vertically after the nut being returned to its original direction although the nut can be mounted to the fixing bolt fast. Moreover, the nut is not provided with structural designs for returning the direction. Thus the nut may have tilt or shaking in different degrees. Such tilt and shaking make the first internal thread and the second internal thread of the nut unable to engage with outer thread of the fixing bolt smoothly or effectively and the engagement is not smooth or the nut is not aligned properly with the bolt. During tightening process, the installer may need to loosen and tighten the nut multiple times for tight fastening. Thus the installer's experience and operating feeling play an important role during the threading and tightening of the nut. There is room for improvement and there is a need to provide a nut which makes the operation easier, more stable and user-friendly.

### SUMMARY

Therefore, it is a primary object of the present invention to provide a quick install nut able to be installed and fastened easily, smoothly, quickly, and securely. The quick install nut is especially suitable for installation and fastening of bathroom fittings or accessories.

In order to achieve the above objects, a quick install nut according to the present invention includes a threaded member and a driving member. The threaded member consists of a threaded portion and a first mounting portion extending from a top end of the threaded portion.

The threaded portion is composed of a first hole and a second hole spaced apart and staggered relatively to each other along an axis, a first opening communicating with the first hole, a second opening communicating with the second hole, and a separating slot formed between the first hole and the second hole. The first hole and the second hole are respectively provided with a segment of first internal threads corresponding to the first opening and a segment of second internal threads corresponding to the second opening. A mounting slot with an opening facing upward and a side opening are defined in the first mounting portion. The mounting slot is vertically communicating with the second hole while the side opening is radially communicating with the mounting slot and vertically communicating with the second opening. The nut is tilted and moved with respect to the bolt for allowing the bolt to pass through the first opening, the separating slot, and the second opening in turn. Then the nut is returned to make an axis of the bolt align with the axis X1 of the nut and the bolt is mounted into the mounting slot, the first hole, and the second hole through the side opening to be engaged with the first internal threads and the second internal threads.

The driving member can be vertically limited and mounted to the first mounting portion of the threaded member and rotated between an open position and a driving position. The driving member is composed of a closed ring mounted in the mounting slot, an insertion slot defined in the closed ring and vertically communicating with the second hole, and an inlet formed radially on the closed ring. The inlet is aligned with the side opening while the driving member is at the open position for allowing the bolt to enter the insertion slot through the inlet. While the driving member is at the driving position, the side opening is closed by the inlet for stopping the bolt from moving radially along the side opening. The bolt is further forced to be engaged with the first internal threads and the second internal threads. When the driving member is rotated to the driving position, the threaded member is driven to be tightly threaded to the bolt.

Another quick install nut according to the present invention is provided and composed of a threaded member, a driving member, and a closing member.

The threaded member consists of a threaded portion and a mounting portion extending from a top end of the threaded portion. The threaded portion is composed of a first hole and a second hole spaced apart and staggered relatively to each other along an axis, a first opening communicating with the first hole, a second opening communicating with the second hole, and a separating slot formed between the first hole and the second hole. The first hole and the second hole are respectively provided with a segment of first internal threads corresponding to the first opening and a segment of second internal threads corresponding to the second opening. A mounting slot with an opening facing upward and a side opening are defined in the mounting portion. The mounting slot is vertically communicating with the second hole while the side opening is radially communicating with the mounting slot and vertically communicating with the second opening. The nut is tilted and moved with respect to the bolt for allowing the bolt to pass through the first opening, the separating slot, and the second opening in turn. Then the nut is returned to make an axis of the bolt align with the axis of the nut and the bolt is mounted into the mounting slot, the first hole, and the second hole through the side opening to be engaged with the first internal threads and the second internal threads.

The driving member is able to be vertically limited and mounted to the mounting portion of the threaded member and rotated between an open position and a driving position. An inlet channel is formed radially on the driving member and aligned with the side opening while the driving member is at the open position for allowing the bolt to enter the inlet radially through the inlet channel.

The closing member is mounted and limited vertically in the mounting slot, able to be driven by the driving member to rotate between an initial position and an end position. The closing member includes an insertion slot defined therein and vertically communicating with the second hole, and an inlet formed radially and aligned with the side opening while the closing member is at the initial position for allowing the bolt inserted through the inlet channel to enter the insertion slot. When the driving member is rotated to the driving position, the inlet is driven to the end position for closing the side opening and further stopping the bolt from moving radially toward the side opening. Thus the bolt is forced to keep engaged with the first internal threads and the second internal threads. When the driving member is rotated to the driving position, the threaded member is driven to be tightly threaded to the bolt.

A further quick install nut according to the present invention is provided and including a threaded member, a driving member, and a closing member.

The threaded member consists of a threaded portion and a mounting portion extending from a top end of the threaded portion. The threaded portion includes a hole extending along an axis and an opening communicating with the hole. The hole is provided with a segment of internal threads corresponding to the opening. A mounting slot with an opening facing upward and a side opening are defined in the mounting portion. The mounting slot is vertically communicating with the hole while the side opening is radially communicating with the mounting slot and vertically communicating with the opening. A bolt horizontally inserted through the opening and the side opening is able to enter the mounting slot and the hole to be engaged with the internal threads.

The driving member is able to be vertically limited and mounted to the mounting portion of the threaded member and rotated between an open position and a driving position. An inlet channel is formed radially on the driving member and aligned with the side opening while the driving member is at the open position for allowing the bolt to enter the inlet radially through the inlet channel.

The closing member is mounted and limited vertically in the mounting slot, able to be driven by the driving member to rotate between an initial position and an end position. The closing member includes an insertion slot defined therein and vertically communicating with the hole, and an inlet formed radially and aligned with the side opening while the closing member is at the initial position for allowing the bolt inserted through the inlet channel to enter the insertion slot. When the driving member is rotated to the driving position, the inlet is driven to the end position for closing the side opening and further stopping the bolt from moving radially toward the side opening. Thus the bolt is forced to keep engaged with the internal threads. When the driving member is rotated to the driving position, the threaded member is driven to be tightly threaded to the bolt.

The present quick install nut can be tilted an angle and mounted to a bolt or directly mounted to the bolt by horizontal movement and then returned for further operation to make the bolt engage with the two segments of internal threads or the single segment of threads in the threaded member. Through initial rotation of the driving member, the bolt is enclosed in the nut and maintained at the engagement state by the closed ring inside the driving member or the closing member. Thus the driving member and the threaded member are engaged with the bolt stably and firmly during the following rotation and tightening of the threaded member to the bolt driven by the driving member. Therefore, easy, smooth, quick and secure fastening is attained.

### BRIEF DESCRIPTION OF THE DRAWINGS

FIG. 1 is a perspective view of a nut of an embodiment according to the present invention;

FIG. 2 is an exploded view of a nut of an embodiment according to the present invention;

FIG. 3 is a front perspective sectional view along a second opening of a nut of the embodiment in FIG. 1 according to the present invention;

FIG. 4 is a cross sectional view along an elastic locking block of a nut of the embodiment in FIG. 1 according to the present invention;

FIG. 5 is a cross sectional view along a positioning block of a nut showing an imaginary bolt relatively moved into and engaged with a first hole and a second hole of the embodiment in FIG. 1 according to the present invention;

FIG. 6 is a perspective view of a threaded member of an embodiment according to the present invention;

FIG. 7 is a bottom perspective view of a driving member of an embodiment according to the present invention;

FIG. 8 is a cross sectional view showing a driving member rotated to a driving position of the embodiment in FIG. 5 according to the present invention;

FIG. 9 is a perspective view of a nut of another embodiment according to the present invention;

FIG. 10 is an exploded view of a nut of another embodiment according to the present invention;

FIG. 11 is a front perspective sectional view along a second opening of a nut of the embodiment in FIG. 9 according to the present invention;

FIG. 12 is a cross sectional view along a positioning block of a nut of the embodiment in FIG. 9 according to the present invention;

FIG. 13 is a bottom perspective view of a driving member of another embodiment according to the present invention;

FIG. 14 is a cross sectional view showing a positioning block released from a positioning recess after a driving member of the embodiment in FIG. 9 being rotated according to the present invention;

FIG. 15 is a cross sectional view showing a positioning block abutting against a stopping block after a driving member of the embodiment in FIG. 14 being rotated according to the present invention;

FIG. 16 is a perspective view of a nut of a further embodiment according to the present invention;

FIG. 17 is a front perspective sectional view along a second opening of a nut of the embodiment in FIG. 16 according to the present invention;

FIG. 18 is a front perspective sectional view along a second opening of a threaded member of a further embodiment according to the present invention.

### DETAILED DESCRIPTION

Please refer to the following embodiments and figures of the present invention for further description.

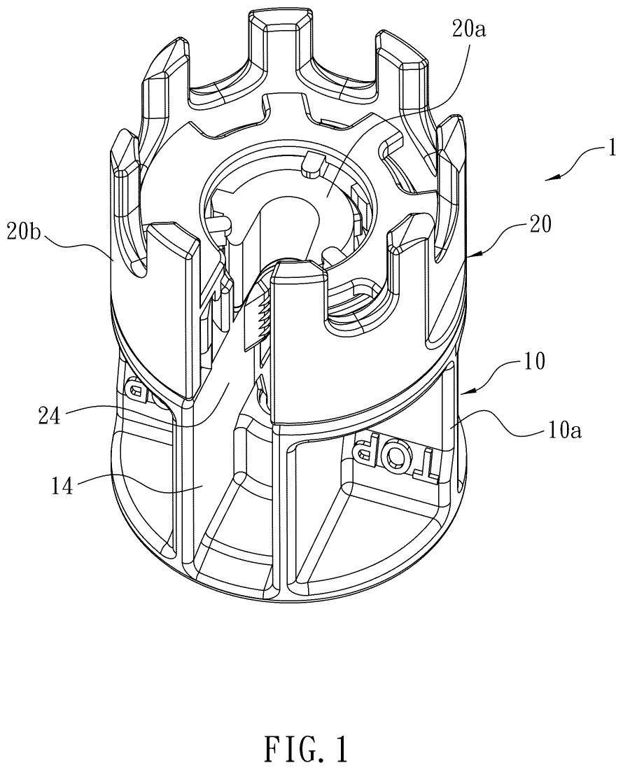

As shown in FIGS. 1-5, a first embodiment of a quick install nut according to the present invention is provided. A nut 1 according to the present invention can be used in combination with a threaded parts or analogues such as a bolt 2 to join two objects together quickly or fasten the two objects onto a third object.

The nut 1 includes a threaded member 10 and a driving member 20.

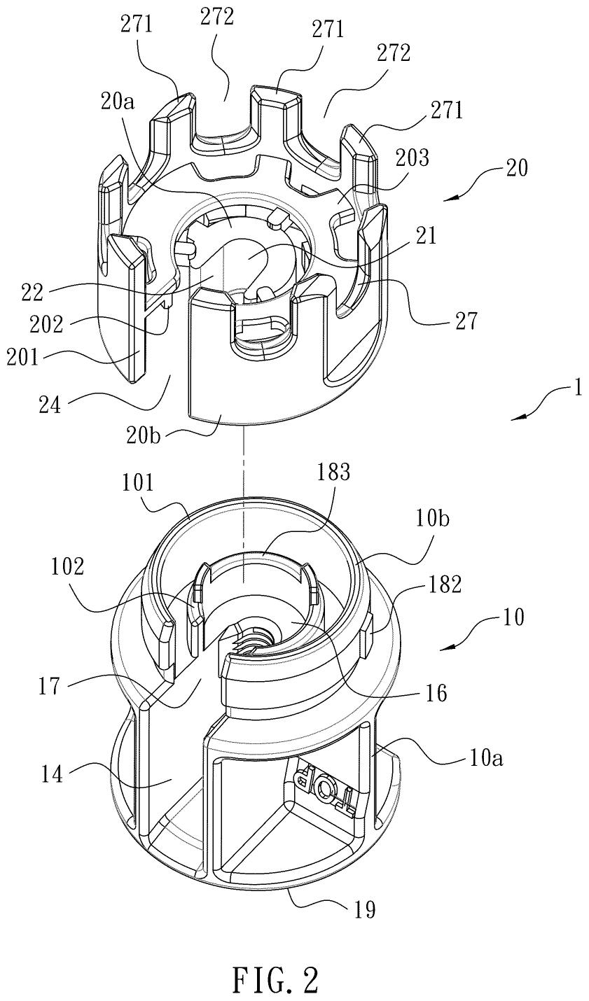

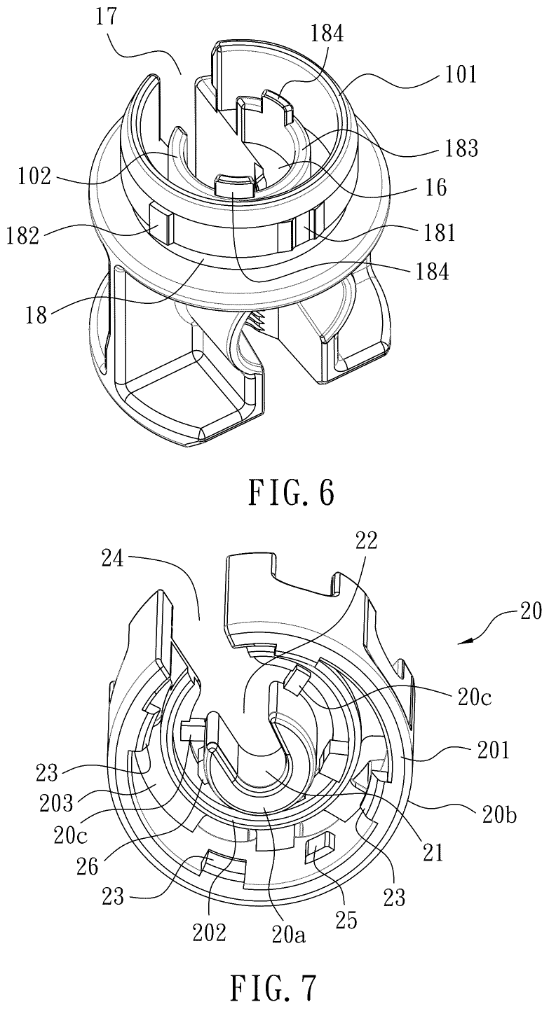

As shown in FIG. 2 and FIG. 6, the threaded member 10 consists of a threaded portion 10a and a first mounting portion 10b extending from a top end of the threaded portion 10a. The threaded portion 10a is composed of a first hole 11 and a second hole 12 spaced apart and staggered relatively to each other along an axis X1 of the nut 1, a first opening 13 communicating with the first hole 11, a second opening 14 communicating with the second hole 12, a separating slot 15 located between the first hole 11 and the second hole 12, a mounting slot 16 provided with an opening facing upward and defined in the first mounting portion 10b, and a side opening 17 defined in the first mounting portion 10b. The first hole 11 and the second hole 12 are respectively provided with a segment of first internal threads 111 corresponding to the first opening 13 and a segment of second internal threads 121 corresponding to the second opening 14. The mounting slot 16 is vertically communicating with the second hole 12 while the side opening 17 is radially communicating with the mounting slot 16 and vertically communicating with the second opening 14. The nut 1 is tilted and moved with respect to the bolt 2 for allowing the bolt 2 to pass through the first opening 13, the separating slot 15, and the second opening 14 in turn. Then the nut 1 is returned to make an axis of the bolt 2 align with the axis X1 of the nut 1 and the bolt 2 is mounted into the mounting slot 16, the first hole 11, and the second hole 12 through the side opening 17 to be engaged with the first internal threads 111 and the second internal threads 121.

As shown in FIG. 2 and FIG. 7, the driving member 20 can be vertically limited and mounted to the first mounting portion 10b of the threaded member 10 and rotated to be switched between an open position and a driving position. The driving member 20 is composed of a closed ring 20a mounted in the mounting slot 16, an insertion slot 21 defined in the closed ring 20a and vertically communicating with the second hole 12, and an inlet 22 formed radially on the closed ring 20a. The inlet 22 is aligned with the side opening 17 while the driving member 20 is at the open position for allowing the bolt 2 to enter the insertion slot 21 through the inlet 22. While the driving member 20 is at the driving position, the side opening 17 is closed by the inlet 22 for stopping the bolt 2 from moving radially along the side opening 17. The bolt 2 is further forced to be engaged with the first internal threads 111 and the second internal threads 121. When the driving member 20 is rotated to the driving position, the threaded member 10 is driven by the driving member 20 to be threaded and tightened to the bolt 2.

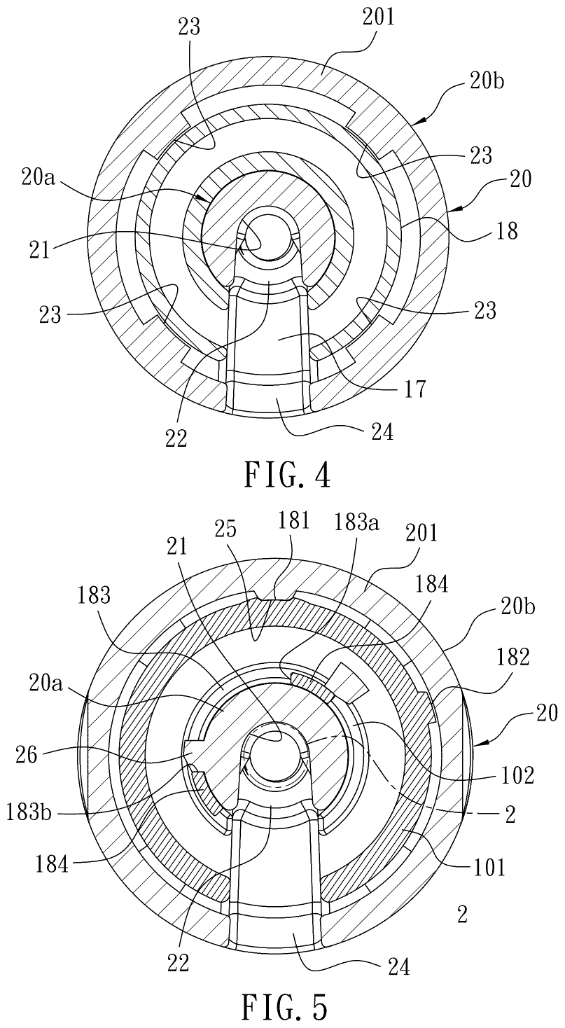

In this embodiment, the first mounting portion 10b of the threaded member 10 consists of a C-shaped outer circular wall 101 and a C-shaped inner circular wall 102 radially separated from each other. A circular locking groove 18 is disposed concavely on an outer wall of the C-shaped outer circular wall 101. A second mounting portion 20b is connected to and located around the closed ring 20a of the driving member 20. At least one elastic locking block 23 is projecting from an inner wall of the second mounting portion 20b. As shown in FIG. 4 and FIG. 7, there are four elastic locking blocks 23. The elastic locking block 23 is able to be elastically locked and vertically limited in the circular locking groove 18 by downward sliding. An inlet channel 24 is radially disposed on the second mounting portion 20b and radially communicating with the inlet 22 of the closed ring 20a for allowing the bolt 2 to enter the inlet 22 through the inlet channel 24.

In this embodiment, a positioning recess 181 and a stopping block 182 are disposed on the C-shaped outer circular wall 101 in a circumferential direction and located above the circular locking groove 18, as shown in FIG. 5 and FIG. 6. Refer to FIG. 7, a positioning block 25 is arranged at the inner wall of the second mounting portion 20b. The positioning block 25 can be slid downward to be mounted and positioned in the positioning recess 181 vertically when the driving member 20 is at the open position. The positioning block 25 is able to be released from the positioning recess 181 when the driving member 20 is rotated toward the driving position. When the driving member 20 reaches the driving position, the positioning block 25 is abutting against the stopping block 182 for driving the threaded member 10 to rotate.

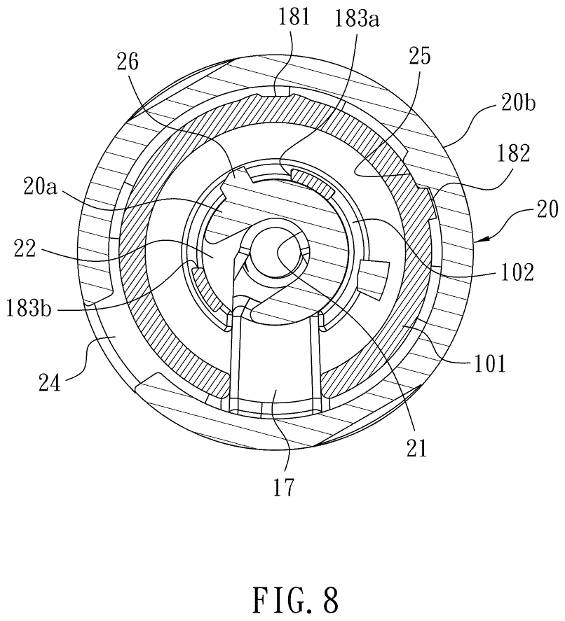

As shown in FIG. 7, in this embodiment, the second mounting portion 20b includes an outer wall portion 201, an inner wall portion 202, and a connection portion 203 connected with both the outer wall portion 201 and the inner wall portion 202. The outer wall portion 201 is mounted around the outer wall of the C-shaped outer circular wall 101 while the elastic locking block 23 and the positioning block 25 are formed on an inner wall of the outer wall portion 201. The inner wall portion 202 is mounted and positioned on an inner wall of the C-shaped inner circular wall 102. At least one breakable portion 20c is located between and connected to the inner wall portion 202 and the closed ring 20a. There are three breakable portions 20c in this embodiment as shown in the figures. Refer to FIG. 6, the C-shaped inner circular wall 102 is provided with a limit curved groove 183 which is defined by two projecting ribs 184. The closed ring 20a is provided with a limit block 26 able to be mounted in the limit curved groove 183 and allowed to be rotated between an initial position and an end position. In this embodiment, as shown in FIG. 5, the limit block 26 is at the initial position while the driving member 20 is at the open position. When the driving member 20 is rotated to the driving position, as shown in FIG. 8, the limit block 26 is close to the end position.

Thereby when the driving member 20 is rotated to the driving position and the threaded member 10 is driven to be tightly threaded to the bolt 2 to achieve a certain torque such as 3.39 Nm (Newton meter), the positioning block 25 of the driving member 20 will slide and release from the stopping block 182 to have idle rotation. When the limit block 26 is rotated to the end position, the limit block 26 and a corresponding wall surface 183a of the limit curved groove 183 are abutting against each other so that the closed ring 20a is unable to be rotated anymore. At the moment, the threaded member 10 is reaching the maximum torque and difficult to be rotated. While being rotated continuously, a torque applied to the driving member 20 will act on the breakable portions 20c of the closed ring 20a and the breakable portions 20c are forced to be twisted and broken. Thus the driving member 20 is further allowed to have idle rotation. After breakage of the breakable portions 20c, the closed ring 20a loses connection with (is no more connected with) the second mounting portion 20b. Therefore, it is ensured that the mounting slot 16 and the side opening 17 are both closed by the closed ring 20a to be at the closed state.

In another feasible embodiment, when the positioning block 25 of the driving member 20 is rotated to the driving position, the limit block 26 of the closed ring 20a is designed to be just arrived the end position mentioned above. Thereby the idle rotation and the closed state mentioned above can also be attained.

It is easy to understand that tightness between the threaded member 10 and the driving member 20 threaded to each other reaches the maximum value once the breakable portions 20c are twisted and broken. Thus the two objects are fastened together or to a third object by the threaded member 10. Moreover, the driving member 20 is not only unable to drive the threaded member 10 to rotate in a reverse direction through the second mounting portion 20b but also unable to abut against another corresponding wall surface 183b of the limit curved groove 183 reversely for driving the threaded member 10 to rotate through the limit block 26 of the closed ring 20a once the breakable portions 20c are twisted and broken. Thereby the threaded member 10 is unable to be loosened and removed from the bolt 12 by being rotated in a reverse direction.

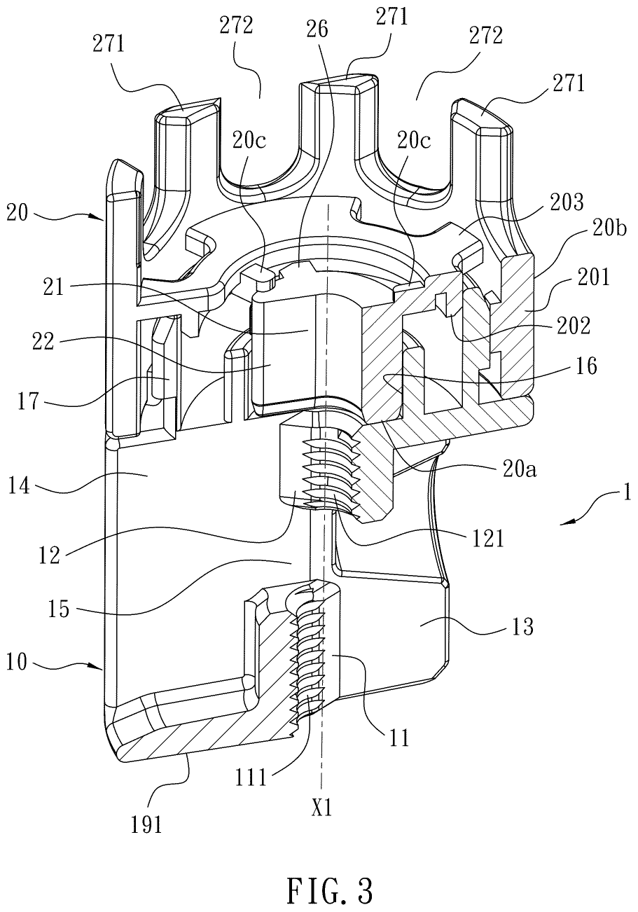

In this embodiment, an end of the threaded member 10 and an end of the driving member 20 away from each other are respectively provided with a packing end 19 and a working end 27. As shown in FIG. 3, a packing end wall 191 is formed on the packing end 19 for adhering to a corresponding wall such as a bottom surface of a toilet so that the toilet is fastened on the at least one bolt 2 installed on a toilet flange. The working end 27 is provided with a plurality of locking blocks 271 and a plurality of locking slots 272. The locking blocks 271 are disposed circularly and projecting from an edge on a top end of the outer wall portion 201. Each of the locking slots 272 is defined between the two adjacent locking blocks 271 for allowing tools to be inserted and turned.

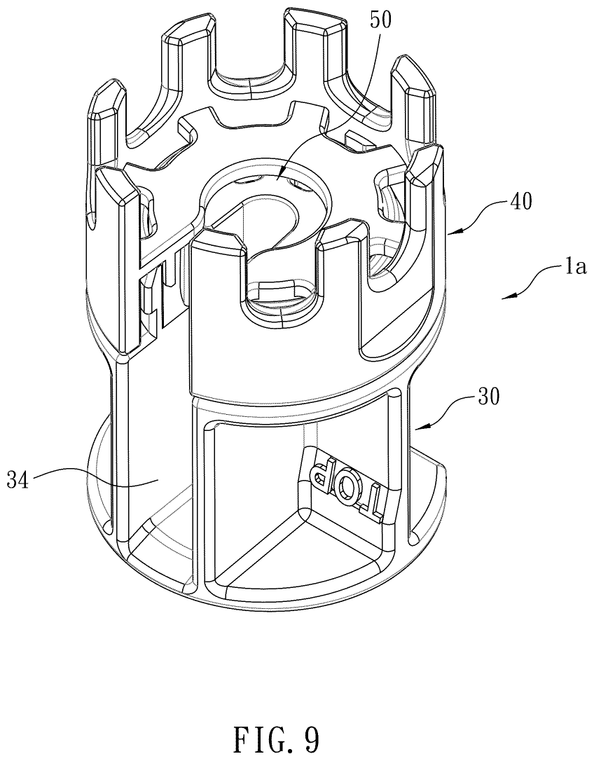

As shown in FIGS. 9-12, a second embodiment of a quick install nut according to the present invention is provided. In this embodiment, a nut 1a consists of three components which is one more component compared with the nut 1 of the first embodiment. In other words, in the nut 1a of this embodiment, the closed ring 20a is detached from the second mounting portion 20b in the nut 1 of the above embodiment to form an independent component. By such design, the two embodiment have similar operations but there are still certain differences in their functions.

To be precise, the nut 1a of this embodiment includes a threaded member 30, a driving member 40, and a closing member 50.

The threaded member 30 consists of a threaded portion 30a and a mounting portion 30b extending from a top end of the threaded portion 30a. The threaded portion 30a includes a first hole 31 and a second hole 32 spaced apart and staggered relative to each other along an axis X2 of the nut 1a, a first opening 33 communicating with the first hole 31, a second opening 34 communicating with the second hole 32, and a separating slot 35 located between the first hole 31 and the second hole 32. The first hole 31 and the second hole 32 are respectively provided with a segment of first internal threads 311 corresponding to the first opening 33 and a segment of second internal threads 321 corresponding to the second opening 34. A mounting slot 36 with an opening facing upward and a side opening 37 are defined in the mounting portion 30b. The mounting slot 36 is vertically communicating with the second hole 32 while the side opening 37 is radially communicating with the mounting slot 36 and vertically communicating with the second opening 34. The nut 1a is tilted and moved with respect to the bolt 2 for allowing the bolt 2 to pass through the first opening 33, the separating slot 35, and the second opening 34 in turn. Then the nut 1a is returned to make an axis of the bolt 2 align with the axis X2 of the nut 1a and the bolt 2 is mounted into the mounting slot 16, the first hole 11, and the second hole 12 through the side opening 17 to be engaged with the first internal threads 111 and the second internal threads 121.

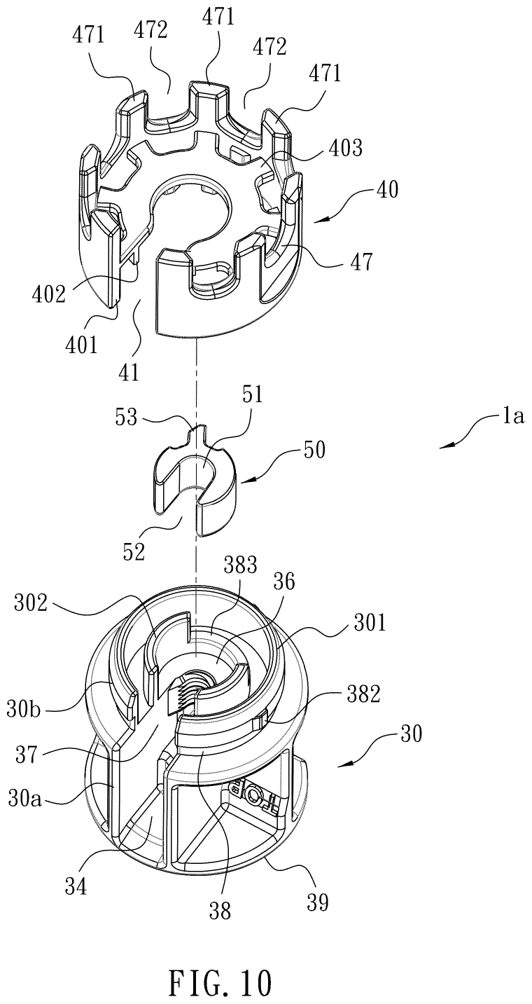

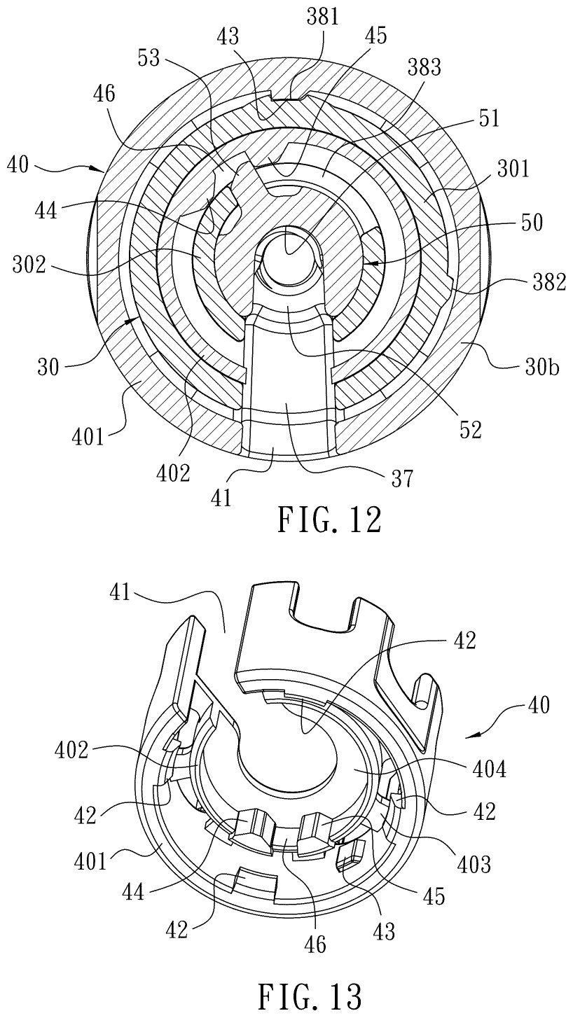

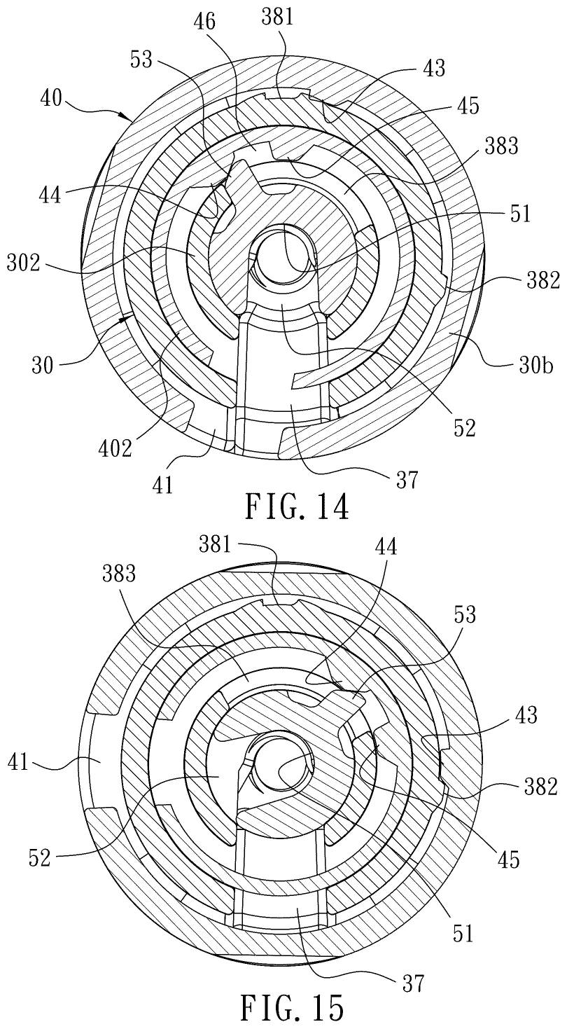

As shown in FIG. 10 and FIG. 13, the driving member 40 is able to be vertically limited and mounted to the mounting portion 30b of the threaded member 30 and rotated to be switched between an open position and a driving position, as shown in FIG. 12, FIG. 14, and FIG. 15. An inlet channel 41 is formed radially on the driving member 40 and aligned with the side opening 37 while the driving member 40 is at the open position for allowing the bolt 2 to enter radially through the inlet channel 41.

The closing member 50 is mounted and limited vertically in the mounting slot 36, able to be driven by the driving member 40 to rotate between an initial position and an end position. The closing member 50 includes an insertion slot 51 defined therein and vertically communicating with the second hole 32, and an inlet 52 formed radially and aligned with the side opening 37 while the closing member 50 is at the initial position for allowing the bolt 2 inserted through the inlet channel 41 to enter the insertion slot 51. As shown in FIG. 15, when the driving member 40 is rotated to the driving position, the closing member 50 is driven to the end position for closing the side opening 37 and further stopping the bolt 2 from radial movement toward the side opening 37. Thus the bolt 2 is forced to keep engaged with the first internal threads 311 and the second internal threads 321. When the driving member 40 is rotated to the driving position, the threaded member 30 is driven to be tightly threaded to the bolt 2.

In this embodiment, the mounting portion 30b of the threaded member 30 consists of a C-shaped outer circular wall 301 and a C-shaped inner circular wall 302 radially separated from each other. A circular locking groove 38 is disposed concavely on an outer wall of the C-shaped outer circular wall 301. At least one elastic locking block 42 is projecting from an inner wall of the driving member 40 and able to be elastically locked and vertically limited in the circular locking groove 38 by downward sliding.

In this embodiment, a positioning recess 381 and a stopping block 382 are disposed on the C-shaped outer circular wall 301 in a circumferential direction and located above the circular locking groove 38. A positioning block 43 is arranged at the inner wall of the driving member 40. When the driving member 40 is at the open position, the positioning block 43 can be slid downward to be locked and positioned in the positioning recess 381. The positioning block 43 is released from the positioning recess 381 when the driving member 40 is rotated toward the driving position, as shown in FIG. 14. While the driving member 40 reaching the driving position, the positioning block 43 is abutting against the stopping block 382 for driving the threaded member 30 to rotate, as shown in FIG. 15.

In this embodiment, as shown in FIG. 10-FIG. 13, the C-shaped inner circular wall 302 is provided with a limit curved groove 383. The driving member 40 includes an outer wall portion 401, an inner wall portion 402, and a connection portion 403 connected with both the outer wall portion 401 and the inner wall portion 402. The outer wall portion 401 is mounted around the outer wall of the C-shaped outer circular wall 301 while the elastic locking block 42 and the positioning block 43 are formed on an inner wall of the outer wall portion 401. The inner wall portion 402 is mounted and positioned on an inner wall of the C-shaped inner circular wall 302 and a forward pusher 44 is projecting from an inner surface of the inner wall portion 402. A turning block 53 projecting from an outer surface of the closing member 50 is able to be mounted in the limit curved groove 383 and allowed to be rotated between the initial position and the end position. Along with the driving member 40 being rotated from the open positon to the driving position, the turning block 53 located at the initial position is pushed by the forward pusher 44 and rotated to the end position for closing the side opening 37, as shown in FIG. 14 and FIG. 15.

In this embodiment, as shown in FIG. 13, a stopping wall 404 is radially extending from the inner wall portion 402 of the driving member 40 and used for vertically stopping and limiting the closing member 50 in the mounting slot 36.

In this embodiment, a backward pusher 45 is arranged at and projecting from the inner surface of the inner wall portion 402. A mounting groove 46 is formed between the forward pusher 44 and the backward pusher 45 and used for mounting the turning block 53 of the closing member 50. Along with the driving member 40 being rotated reversely from the driving positon to the open position, the turning block 53 located at the end position is pushed by the backward pusher 45 and rotated reversely to the initial position. Along with continuous reverse rotation and movement of the driving member 40, the backward pusher 45 can push the threaded member 30 through the turning block 53. Thus the threaded member 30 is further rotated reversely and loosened.

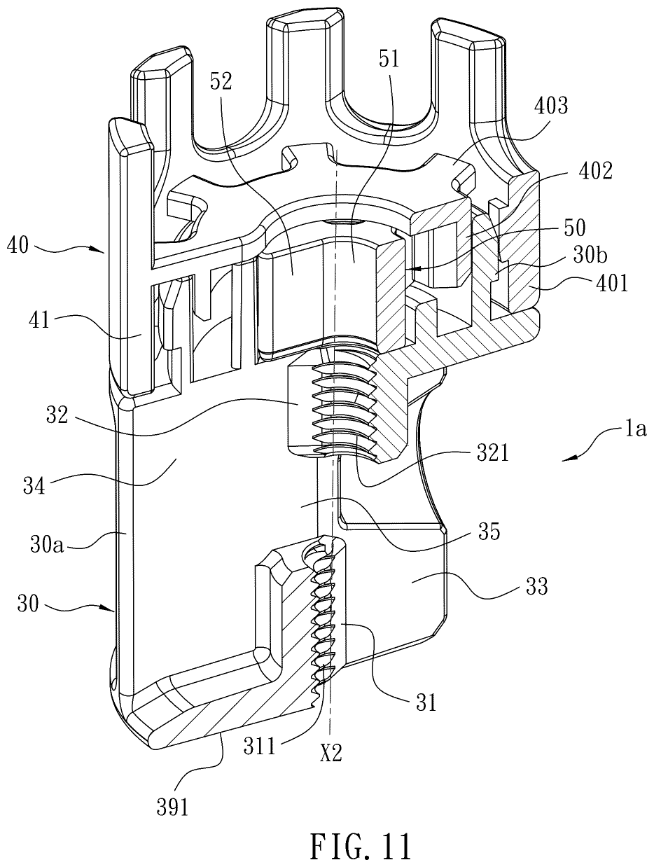

In this embodiment, as shown in FIG. 10, a packing end 39 and a working end 47 are respectively formed on an end of the threaded member 30 and an end of the driving member 40 away from each other. As shown in FIG. 11, a packing end wall 391 is formed on the packing end 39 for attachment to a corresponding wall such as a bottom surface of a toilet so that the toilet is fastened on the at least one bolt 2 which is installed on a toilet flange. The working end 47 is provided with a plurality of locking blocks 471 and a plurality of locking slots 472. The locking blocks 471 are disposed circularly and projecting from an edge on a top end of the outer wall portion 401 and each of the locking slots 472 is defined between the two adjacent locking blocks 471 for allowing tools to be inserted and turned.

The driving member 40 is installed and positioned on the threaded member 30 while at the open position. When the driving member 40 is at the open position, the positioning block 43 can be slid vertically to be mounted and positioned in the positioning recess 381 of the threaded member 30. At the same time, the inlet channel 41 of the driving member 40 and the side opening 37 are aligned with each other. Thereby installers [symbol] can incline the nut 1a so that a tilt angle is formed between the nut 1a and the bolt 2 and the nut 1a can be mounted to the bolt 2 quickly. That means the bolt 2 is passed through the first opening 33, the separating slot 35, and the second opening 34 in turn. Then the nut 1a is returned to make the axis of the bolt 2 align with the axis X2 of the nut 1a and the bolt 2 is forced to insert into the mounting slot 36, the first hole 31, and the second hole 32 through the side opening 37. Lastly the bolt is engaged with the first internal threads 311 and the second internal threads 321. Thus the first-stage operation is completed.

It should be particularly noted that the at the first stage operation, as shown in FIG. 12, the driving member 40 is at the initial position and the turning block 53 of the closing member 50 is mounted in the mounting groove 46 formed between the forward pusher 44 and the backward pusher 45. The turning block 53 and the backward pusher 45 are abutting against each other and there is a gap between the turning block 53 and the forward pusher 44. The purpose of the above design is for allowing the positioning block 43 to be released from the positioning recess 381 first when the installer rotates the driving member 40. Then the turning block 53 is pushed by the forward pusher 44 and the closing member 50 is forced to rotate. Such design can reduce operation resistance in the beginning and this helps the positioning block 43 to be released from the positioning recess 381, but not limited. The gap mentioned above can also be omitted.

At the second stage operation, the driving member 40 is rotated toward a fastening direction. That means the driving member 40 is rotated from the open position to the driving position for allowing the positioning block 43 to be released from the positioning recess 381 first, as shown in FIG. 14. Later the turning block 53 of the closing member 50 is pushed by the forward pusher 44 and rotated toward the end position. As shown in FIG. 15, when the driving member 40 reaches the driving position, in fact, the positioning block 43 is rotated to a position that the positioning block 43 and the stopping block 382 are abutting against each other. Yet the turning block 53 has not reached the end position. That means there is still a gap between the turning block 53 and a corresponding wall surface of the limit curved groove 383. Under such condition, the installer continues rotating the driving member 40 so that the positioning block 43 pushes the stopping block 382 to drive the threaded member 30 to rotate until primary fastening is completed.

As to the third stage operation, the driving member 40 is rotated finely at this last stage. Through this fine rotation, the turning block 53 of the closing member 50 reaches the end position, unable to be rotated any more. The positioning block 43 is pushed toward a radial direction by the stopping block 382 and is elastically expanded outward a bit. At the moment, the maximum fastening torque is achieved and fastening of the nut 1a is completed.

The design of the nut 1a allows the installer to loosen and remove the nut 1a by reverse rotation of the driving member 40 so that the nut 1a of this embodiment is a bit different from the nut 1 of the first embodiment. It is easy to understand that during reverse rotation, first the positioning block 43 is separated from the stopping block 382 and no more elastic expansion is generated. Then the backward pusher 45 of the driving member 40 is abutting against the turning block 53. Now along with the continuous reverse rotation of the driving member 40, the positioning block 43 is slid to be mounted and positioned into the positioning recess 381 of the threaded member 30 again. At the same time, the turning block 53 is also returned to the initial position and abutting against the corresponding wall surface of the limit curved groove 383. Thereby the nut 1a is back to the first stage operation mentioned above to allow the inlet channel 41 of the driving member 40 and side opening 37 align with each other. That means the installer can tilt the nut 1a again to make the first internal threads 311, the second internal threads 321, and the bolt 2 release from the engagement state. Thus the nut 1a is removed from the bolt 2 fast and the whole loosening and removal process is completed.

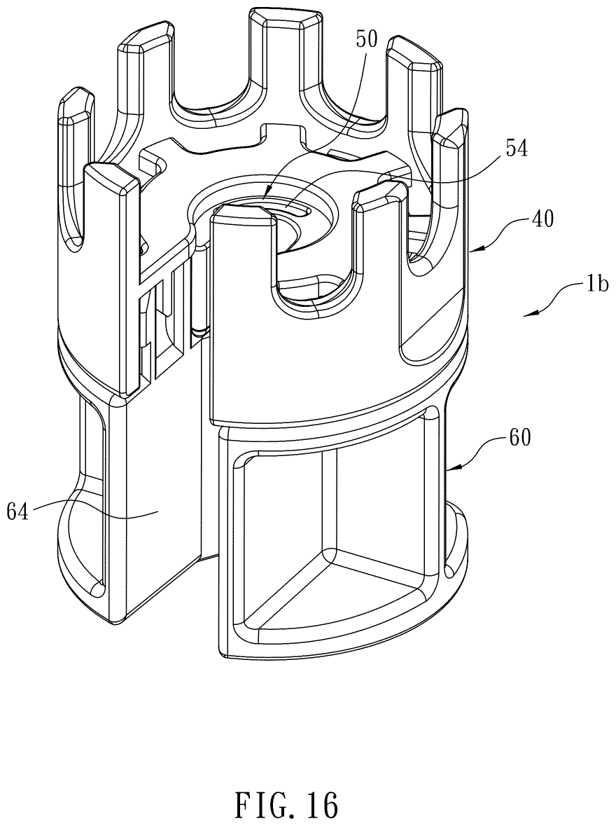

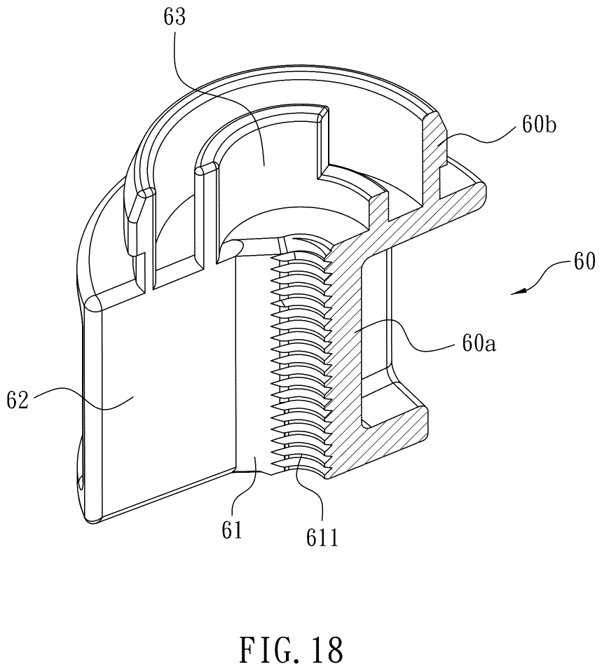

As shown in FIGS. 16-18, a third embodiment of a quick install nut is provided. A nut 1b of this embodiment is about the same as the nut 1a of the second embodiment and the difference between them is in that: a threaded member 60 of this embodiment is a bit different from the threaded member 30 of the second embodiment, especially some changes in design of the engagement structure. The nut 1b can be installed fast without being inclined with a tilt angle.

More specifically, the threaded member 60 of this embodiment consists of a threaded portion 60a and a mounting portion 60b extending from a top end of the threaded portion 60a. The threaded portion 60a includes a hole 61 extending along an axis X3 of the nut 1b, an opening 62 communicating with the hole 61, a mounting slot 63 with an opening facing upward and defined in the mounting portion 60b, and a side opening 64 defined in the mounting portion 60b. The hole 61 is provided with a segment of internal threads 611 located opposite to the opening 62. The mounting slot 63 is vertically communicating with the hole 61 while the side opening 64 is radially communicating with the mounting slot 63 and vertically communicating with the opening 62.

When the driving member 40 is at the open position, the inlet channel 41 of the driving member 40 is aligned with the side opening 64 of the threaded member 60. The inlet 52 of the closing member 50 at the initial position is also aligned with the side opening 64. The threaded member 60 is designed to have only the single opening 62. Thereby during installation, there is no need to incline the nut 1b. The opening 62, the side opening 64, and the inlet 52 of the threaded member 60 are aligned with the bolt 2 and then the nut 1b is moved horizontally. Thus the bolt 2 is horizontally passed through the opening 62, the side opening 64, and the inlet 52, then entering the hole 61 to be engaged with the internal threads 611. Next the driving member 40 is rotated and the steps about the same as the second embodiment are performed to complete fastening of the nut 1b. Moreover, loosening and removal of the nut 1b are about the same as the second embodiment.

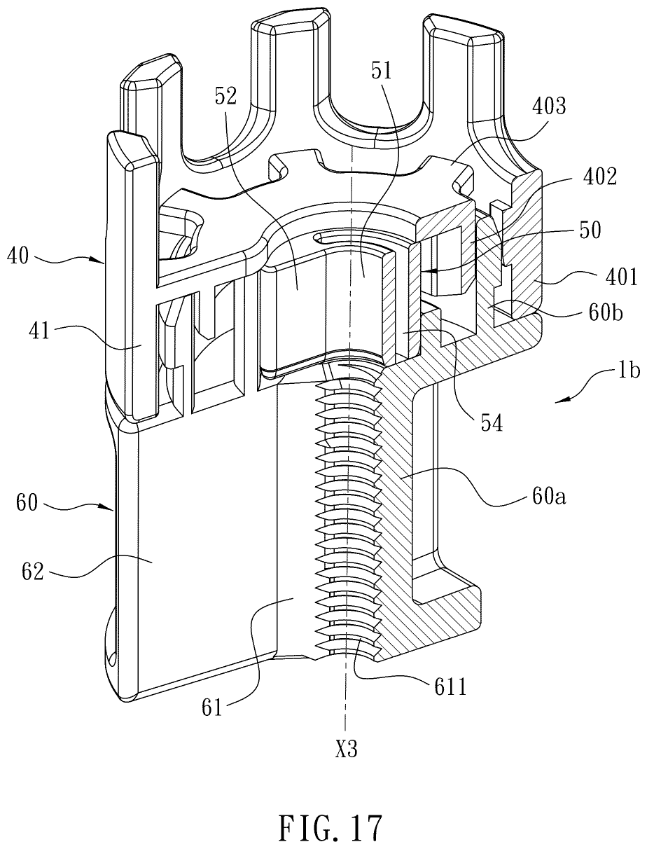

It should be noted that an idle rotating operation mode may be provided at the third stage operation of the second embodiment by delicate designs such as specific structure, dimension tolerance, and material flexibility. More specifically, if the elastic deformation is generated between not only the positioning block 43 and the stopping block 382 but also the forward pusher 44 and the turning block 53 for allowing the positioning block 43 to slide through the stopping block 382 and the forward pusher 44 to slide through the turning block 53 respectively, the driving member 40 is allowed to have idle rotation when the turning block 53 of the closing member 50 reaches the end position and unable to be rotated any more. The advantage is in that the nut 1a has reached the maximum torque when the installer rotates the nut 1a until the driving member 40 has idle rotation. Such design makes the operation more user-friendly. In the third embodiment, the closing member 50 is provided with a slotted hole 54 which makes the turning block 53 have larger elastic deformation or recession, as shown in FIG. 16 and FIG. 17. Such designs all attain the same effects mentioned above. Moreover, the reverse rotation will not be affect by the above design. The loosening and operation are about the same as those mentioned above.

In summary, the present quick install nut can allow the bolt 2 to be engaged with the threaded member 10, 30, 60 no matter the nut is first tilted, mounted to the bolt 2, and then returned, or directly mounted to the bolt by horizontal movement. Through initial rotation of the driving member 20, 40, the bolt 2 is enclosed in the nut 1, 1a, 1b and maintained at the engagement state by the closed ring 20a inside the driving member 20 or the closing member 50. Thus users don't need to worry about vibration or inclination generated during tightening which may cause loosening and improper engagement and the bolt should be loosened and then tightened again. Therefore, the nut of the present invention provides easy, smooth, quick and secure fastening.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A quick install nut comprising:
a threaded member having a threaded portion and a first mounting portion extending from a top end of the threaded portion; the threaded portion including a first hole and a second hole spaced apart and staggered relatively to each other along an axis of the nut, a first opening communicating with the first hole, a second opening communicating with the second hole, a separating slot formed between the first hole and the second hole, a mounting slot provided with an opening facing upward and defined in the first mounting portion, and a side opening defined in the first mounting portion; the first hole and the second hole respectively provided with a segment of first internal threads corresponding to the first opening and a segment of second internal threads corresponding to the second opening; the mounting slot vertically communicating with the second hole while the side opening radially communicating with the mounting slot and vertically communicating with the second opening; a bolt tilted with respect to the nut and passed through the first opening, the separating slot, and the second opening in turn being aligned with the axis of the nut and mounted into the mounting slot, the first hole, and the second hole through the side opening to be engaged with the first internal threads and the second internal threads;
a driving member able to be vertically limited and mounted to the first mounting portion of the threaded member and rotated between an open position and a driving position; the driving member having a closed ring mounted in the mounting slot, an insertion slot defined in the closed ring and vertically communicating with the second hole, and an inlet formed radially on the closed ring; the inlet aligned with the side opening while the driving member is at the open position for allowing the bolt to enter the insertion slot through the inlet; the side opening being closed by the inlet for stopping the bolt from moving radially along the side opening and further forcing the bolt to be engaged with the first internal threads and the second internal threads when the driving member is at the driving position; the threaded member being driven to be tightly threaded to the bolt when the driving member is rotated to the driving position.

2. The quick install nut as claimed in claim 1, wherein the first mounting portion of the threaded member includes a C-shaped outer circular wall and a C-shaped inner circular wall radially separated from each other; a circular locking groove is disposed concavely on an outer wall of the C-shaped outer circular wall; a second mounting portion is connected to and located around the closed ring of the driving member; at least one elastic locking block is projecting from an inner wall of the second mounting portion and able to be elastically locked and vertically limited in the circular locking groove by downward sliding; an inlet channel is radially disposed on the second mounting portion and radially communicating with the inlet of the closed ring for allowing the bolt to enter the inlet through the inlet channel.

3. The quick install nut as claimed in claim 2, wherein a positioning recess and a stopping block are disposed on the C-shaped outer circular wall in a circumferential direction and located above the circular locking groove; a positioning block is arranged at the inner wall of the second mounting portion; the positioning block is slid downward to be mounted and positioned in the positioning recess when the driving member is at the open position; the positioning block is released from the positioning recess when the driving member is rotated toward the driving position; the positioning block is abutting against the stopping block for driving the threaded member to rotate when the driving member reaches the driving position.

4. The quick install nut as claimed in claim 3, wherein the second mounting portion includes an outer wall portion, an inner wall portion, and a connection portion connected with the outer wall portion and the inner wall portion; the outer wall portion is mounted around the outer wall of the C-shaped outer circular wall while the elastic locking block and the positioning block are formed on an inner wall of the outer wall portion; the inner wall portion is mounted and positioned on an inner wall of the C-shaped inner circular wall; at least one breakable portion is located between and connected to the inner wall portion and the closed ring; the C-shaped inner circular wall is provided with a limit curved groove and the closed ring is provided with a limit block able to be mounted in the limit curved groove and allowed to be rotated between an initial position and an end position; when the driving member drives the threaded member to be tightly threaded to the bolt and a certain torque is achieved, the positioning block at the driving position is released from the stopping block to have idle rotation; the limit block rotated to the end position is stopped reversely and the breakable portion of the closed ring is forced to be twisted and broken; thus the mounting slot and the side opening are both maintained at a closed state.

5. The quick install nut as claimed in claim 4, wherein an end of the threaded member and an end of the driving member away from each other are respectively provided with a packing end and a working end; a packing end wall is formed on the packing end for adhering to a corresponding wall; the working end is provided with a plurality of locking blocks and a plurality of locking slots; the locking blocks are disposed circularly and projecting from an edge on a top end of the outer wall portion and each of the locking slots is defined between the two adjacent locking blocks for allowing tools to be inserted and turned.

6. A quick install nut comprising:
a threaded member having a threaded portion and a mounting portion extending from a top end of the threaded portion; the threaded portion including a first hole and a second hole spaced apart and staggered relatively to each other along an axis of the nut, a first opening communicating with the first hole, a second opening communicating with the second hole, a separating slot formed between the first hole and the second hole, a mounting slot with an opening facing upward and defined in the mounting portion, and a side opening defined in the mounting portion; the first hole and the second hole respectively provided with a segment of first internal threads corresponding to the first opening and a segment of second internal threads corresponding to the second opening; the mounting slot vertically communicating with the second hole while the side opening radially communicating with the mounting slot and vertically communicating with the second opening; a bolt tilted with respect to the nut and passed through the first opening, the separating slot, and the second opening in turn being aligned with the axis of the nut and mounted into the mounting slot, the first hole, and the second hole through the side opening to be engaged with the first internal threads and the second internal threads;
a driving member able to be vertically limited and mounted to the mounting portion of the threaded member and rotated between an open position and a driving position; an inlet channel formed radially on the driving member and aligned with the side opening while the driving member is at the open position for allowing the bolt to enter the inlet radially through the inlet channel; and
a closing member mounted and limited vertically in the mounting slot and able to be driven by the driving member to rotate between an initial position and an end position; the closing member including an insertion slot defined therein and vertically communicating with the second hole, and an inlet formed radially and aligned with the side opening while the closing member is at the initial position for allowing the bolt inserted through the inlet channel to enter the insertion slot; when the driving member is rotated to the driving position, the closing member being driven to the end position for closing the side opening and further stopping the bolt from moving radially toward the side opening and forcing the bolt to keep engaged with the first internal threads and the second internal threads; the threaded member being driven to be tightly threaded to the bolt when the driving member is rotated to the driving position.

7. The quick install nut as claimed in claim 6, wherein the mounting portion of the threaded member includes a C-shaped outer circular wall and a C-shaped inner circular wall radially separated from each other; a circular locking groove is disposed concavely on an outer wall of the C-shaped outer circular wall; at least one elastic locking block is projecting from an inner wall of the driving member and able to be elastically locked and vertically limited in the circular locking groove by downward sliding.

8. The quick install nut as claimed in claim 7, wherein a positioning recess and a stopping block are disposed on the C-shaped outer circular wall in a circumferential direction and located above the circular locking groove; a positioning block is arranged at the inner wall of the driving member; when the driving member is at the open position, the positioning block is slid downward to be mounted and positioned in the positioning recess; the positioning block is released from the positioning recess when the driving member is rotated toward the driving position; while the driving member reaching the driving position, the positioning block is abutting against the stopping block for driving the threaded member to rotate.

9. The quick install nut as claimed in claim 8, wherein the C-shaped inner circular wall is provided with a limit curved groove; the driving member includes an outer wall portion, an inner wall portion, and a connection portion connected with the outer wall portion and the inner wall portion; the outer wall portion is mounted around the outer wall of the C-shaped outer circular wall while the elastic locking block and the positioning block are formed on an inner wall of the outer wall portion; the inner wall portion is mounted and positioned on an inner wall of the C-shaped inner circular wall and a forward pusher is projecting from an inner surface of the inner wall portion; a turning block projecting from an outer surface of the closing member is mounted in the limit curved groove and allowed to be rotated between the initial position and the end position; along with the driving member being rotated from the open positon to the driving position, the turning block located at the initial position is pushed by the forward pusher and rotated to the end position for closing the side opening.

10. The quick install nut as claimed in claim 9, wherein a backward pusher is arranged at and projecting from the inner surface of the inner wall portion and a mounting groove is formed between the forward pusher and the backward pusher for mounting the turning block of the closing member; along with the driving member being rotated reversely from the driving positon to the open position, the turning block located at the end position is pushed by the backward pusher and rotated reversely to the initial position; along with continuous reverse rotation of the driving member, the backward pusher pushes the threaded member through the turning block and the threaded member is further reversely rotated and loosened.

11. The quick install nut as claimed in claim 9, wherein a packing end and a working end are respectively formed on an end of the threaded member and an end of the driving member away from each other; a packing end wall is formed on the packing end for being attached to a corresponding wall; the working end is provided with a plurality of locking blocks and a plurality of locking slots; the locking blocks are disposed circularly and projecting from an edge on a top end of the outer wall portion and each of the locking slots is defined between the two adjacent locking blocks for allowing tools to be inserted and turned.

12. A quick install nut comprising:
a threaded member having a threaded portion and a mounting portion extending from a top end of the threaded portion; the threaded portion including a hole extending along an axis of the nut, an opening communicating with the hole, a mounting slot with an opening facing upward and defined in the mounting portion, and a side opening defined in the mounting portion; the hole provided with a segment of internal threads corresponding to the opening; the mounting slot vertically communicating with the hole and the side opening radially communicating with the mounting slot and vertically communicating with the opening; a bolt horizontally passed through the opening and the side opening able to be mounted in the mounting slot and the hole and engaged with the internal threads;
a driving member able to be vertically limited and mounted to the mounting portion of the threaded member and rotated between an open position and a driving position; an inlet channel formed radially on the driving member and aligned with the side opening while the driving member is at the open position for allowing the bolt to enter the inlet radially through the inlet channel; and
a closing member mounted and limited vertically in the mounting slot, and able to be driven by the driving member to rotate between an initial position and an end position; the closing member including an insertion slot defined therein and vertically communicating with the hole, and an inlet formed radially and aligned with the side opening while the closing member is at the initial position for allowing the bolt inserted through the inlet channel to enter the insertion slot; when the driving member is rotated to the driving position, the inlet being driven to the end position for closing the side opening and further stopping the bolt from moving radially toward the side opening and forcing the bolt to keep engaged with the internal threads; when the driving member is rotated to the driving position, the threaded member being driven to be tightly threaded to the bolt.

13. The quick install nut as claimed in claim 12, wherein the mounting portion of the threaded member includes a C-shaped outer circular wall and a C-shaped inner circular wall radially separated from each other; a circular locking groove is disposed concavely on an outer wall of the C-shaped outer circular wall; at least one elastic locking block is projecting from an inner wall of the driving member and able to be elastically locked and vertically limited in the circular locking groove by downward sliding.

14. The quick install nut as claimed in claim 13, wherein a positioning recess and a stopping block are disposed on the C-shaped outer circular wall in a circumferential direction and located above the circular locking groove; a positioning block is arranged at the inner wall of the driving member; when the driving member is at the open position, the positioning block is slid downward to be mounted and positioned in the positioning recess; the positioning block is released from the positioning recess when the driving member is rotated toward the driving position; while the driving member reaching the driving position, the positioning block is abutting against the stopping block for driving the threaded member to rotate.

15. The quick install nut as claimed in claim 14, wherein the C-shaped inner circular wall is provided with a limit curved groove; the driving member includes an outer wall portion, an inner wall portion, and a connection portion connected with the outer wall portion and the inner wall portion; the outer wall portion is mounted around the outer wall of the C-shaped outer circular wall while the elastic locking block and the positioning block are formed on an inner wall of the outer wall portion; the inner wall portion is mounted and positioned on an inner wall of the C-shaped inner circular wall and a forward pusher is projecting from an inner surface of the inner wall portion; a turning block projecting from an outer surface of the closing member is mounted in the limit curved groove and allowed to be rotated between the initial position and the end position; along with the driving member being rotated from the open positon to the driving position, the turning block located at the initial position is pushed by the forward pusher and rotated to the end position for closing the side opening.

16. The quick install nut as claimed in claim 15, wherein a backward pusher is arranged at and projecting from the inner surface of the inner wall portion and a mounting groove is formed between the forward pusher and the backward pusher for mounting the turning block of the closing member; along with the driving member being rotated reversely from the driving positon to the open position, the turning block located at the end position is pushed by the backward pusher and rotated reversely to the initial position; along with continuous reverse rotation of the driving member, the backward pusher pushes the threaded member through the turning block and the threaded member is further reversely rotated and loosened.

17. The quick install nut as claimed in claim 15, wherein a packing end and a working end are respectively formed on an end of the threaded member and an end of the driving member away from each other; a packing end wall is formed on the packing end for being attached to a corresponding wall; the working end is provided with a plurality of locking blocks and a plurality of locking slots; the locking blocks are disposed circularly and projecting from an edge on a top end of the outer wall portion and each of the locking slots is defined between the two adjacent locking blocks for allowing tools to be inserted and turned.
